(19) United States
(12) Patent Application Publication
(10) Pub. No.: US 2007/0067262 A1
(43) Pub. Date: Mar. 22, 2007

(54) METHOD AND SYSTEM FOR OPTIMIZING USER DATABASE QUERIES

(76) Inventors: Bhashyam Ramesh, Secunderabad (IN); Michael Watzke, Madison, WI (US)

Correspondence Address: John D. Cowart;Intellectual Property Section, Law Department, NCR Corporation, 1700 South Patterson Blvd., Dayton, OH, 45479-0001, US

(21) Appl. No.: 11/533,513

(22) Filed: Sep. 20, 2006

Related U.S. Application Data
(60) Provisional application No. 60/719,493, filed on Sep. 22, 2005.

(51) Int. Cl. G06F 17/30

(52) U.S. Cl. 707/2

(57) ABSTRACT

A technique for retrieving from a database system data stored in one or more tables is useful in performing cost based query rewrite on user database queries. The technique involves receiving a database query having at least two input relations and evaluating the domain size of the join column(s) of at least one of the input relations. If the domain size of the join column(s) of at least one evaluated input relation is relatively small, the method replaces the input relation(s) in the query with one or more constant expressions. The method also includes evaluating the query and delivering the selected data to the user.

### CROSS-REFERENCE TO RELATED APPLICATION

This application claims benefit of U.S. Provisional Application 60/719,493, filed on Sep. 20, 2005.

### BACKGROUND

Computer systems generally include one or more processors interfaced to a temporary data storage device such as a memory device and one or more persistent data storage devices such as disk drives. Data is usually transferred between the memory device and the disk drives over a communications bus or similar. Once data has been transferred from the disk drives to a memory device accessible by a processor, database software is then able to examine the data to determine if it satisfies the conditions of a query.

In data mining and decision support applications, it is often necessary to scan large amounts of data to include or exclude relational data in an answer set. Where a user query includes more than one input relation it is often necessary to retrieve large amounts of data from the disk drives and to construct intermediate result sets. Much of the intermediate result sets are discarded if the data in the intermediate result sets does not satisfy the conditions of a query.

Some queries are able to undergo semantic query optimization (SQO) that can enable dramatic improvements and performance in such database systems. A SQO uses integrity constraints associated with the database to improve the efficiency of query evaluation. Example SQO techniques include join elimination, predicate introduction, detection of unsatisfiable conditions and predicate elimination.

### SUMMARY

Described below are methods and systems for performing cost based query rewrite on user database queries. The technique is particularly suited to join elimination as a step toward cost based rewrite of a user query.

Described below is a method for use in retrieving from a database system data stored in one or more tables. The method includes the steps of receiving a database query having at least two input relations and evaluating the domain size of the join column(s) of at least one of the input relations. If the domain size of the join column(s) of at least one evaluated input relation is relatively small, the method replaces the input relation(s) in the query with one or more constant expressions. The method also includes the steps of evaluating the query and delivering the selected data to the user.

In one form of the technique the step of replacing the input relation(s) in the query with one or more constant expressions includes the step of creating one or more constant expressions to insert into the query. In another form it includes the step of retrieving one ore more constant expressions from computer memory to insert into the query.

In another form the step of evaluating the domain size of the join column(s) of the input relation(s) comprises checking results maintained in computer memory, the results previously obtained by counting the number of distinct values in the input relation(s).

Also described below is a method for use in retrieving from a database system data stored in one or more tables. The method includes the steps of receiving a database query having at least two input relations and evaluating the cost of executing the query. If the cost of executing the query is higher than an equivalent query that includes one or more constant expressions, the method replaces at least one input relation in the query with one or more of the constant expressions. The method also includes the steps of evaluating the query and delivering the selected data to the user.

Also described is a method for optimizing a database query for retrieving from a database system data stored in one or more tables, the database query having at least two input relations. The method includes the steps of receiving the database query, evaluating the domain size of the join column(s) of at least one of the input relations in the database query, and if the domain size of the join column(s) of at least one evaluated input relation is relatively small, replacing the input relation(s) in the query with one or more constant expressions.

Alternatively, the method includes the steps of receiving the database query, evaluating the cost of executing the query, and if the cost of executing the query is higher than an equivalent query that includes one or more constant expressions, replacing at least one input relation(s) in the query with one or more constant expressions.

Described below is also a database system including one or more tables of data stored on one or more storage facilities and managed by one or more processing units. The system comprises a parsing engine configured to receive a database query having at least two input relations and to coordinate retrieval of data from one or more of the tables of the one or more storage facilities in response to the database query, and a query optimizer configured to evaluate the domain size of at least one input relation and, if the domain size of the input relation(s) is/are relatively small, replace the input relation(s) in the database query with a constant expression.

In one form the query optimizer is further configured to create one or more constant expressions to replace the input relation(s) in the database query with the constant expression(s). In another form the query optimizer is further configured to retrieve one or more constant expressions from computer memory in order to replace the input relation(s) in the database query with the constant expression(s).

In another form of the system the query optimizer is configured to evaluate the domain size of the join column(s) of the input relation(s) by checking results maintained in computer memory, the results previously obtained by counting the number of distinct values in the input relation(s).

Also described is a database system including one or more tables of data stored on one or more storage facilities and managed by one or more processing units. The system comprises a parsing engine configured to receive a database query having at least two input relations and to coordinate retrieval of data from one or more of the tables of the one or more storage facilities in response to the database query, and a query optimizer configured to evaluate the cost of executing the query and, if the cost of executing the query is higher than an equivalent query that includes one or more constant expressions, replace the input relation(s) in the database query with one or more of the constant expressions.

### BRIEF DESCRIPTION OF THE DRAWINGS

FIG. 1 is a block diagram of an exemplary large computer system in which the techniques described below are implemented.

FIG. 2 is a block diagram of the parsing engine of the computer system of FIG. 1.

FIG. 3 is a flow chart of the parser of FIG. 2.

FIG. 4 is a diagram of two exemplary database tables for which query optimization is described.

### DETAILED DESCRIPTION OF DRAWINGS

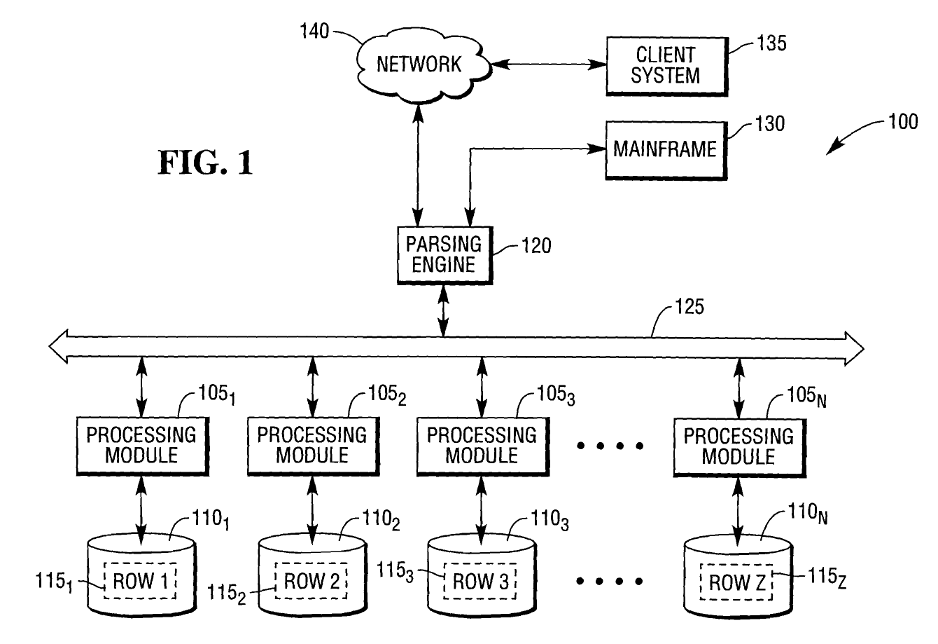

FIG. 1 shows an example of a database system 100, such as a Teradata Active Data Warehousing System available from NCR Corporation. Database system 100 is an example of one type of computer system in which the techniques of managing query optimization are implemented. In computer system 100, vast amounts of data are stored on many disk-storage facilities that are managed by many processing units. In this example, the data warehouse 100 includes a relational database management system (RDMS) built upon a massively parallel processing (MPP) platform.

Other types of database systems, such as object-relational database management systems (ORDMS) or those built on symmetric multi-processing (SMP) platforms, are also suited for use here.

The data warehouse 100 includes one or more processing modules 105_{1 . . . N} that manage the storage and retrieval of data in data storage facilities 110_{1 . . . N}. Each of the processing modules 105_{1 . . . N} manages a portion of a database that is stored in a corresponding one of the data storage facilities 110_{1 . . . N}. Each of the data storage facilities 110_{1 . . . N} includes one or more disk drives.

The system stores data in one or more tables in the data storage facilities 110_{1 . . . N}. The rows 115_{1 . . . Z} of the tables are stored across multiple data storage facilities 110_{1 . . . N} to ensure that the system workload is distributed evenly across the processing modules 105_{1 . . . N}. A parsing engine 120 organizes the storage of data and the distribution of table rows 115_{1 . . . Z} among the processing modules 105_{1 . . . N}. The parsing engine 120 also coordinates the retrieval of data from the data storage facilities 110_{1 . . . N} over network 125 in response to queries received from a user at a mainframe 130 or a client computer 135 connected to a network 140. The database system 100 usually receives queries and commands to build tables in a standard format, such as SQL.

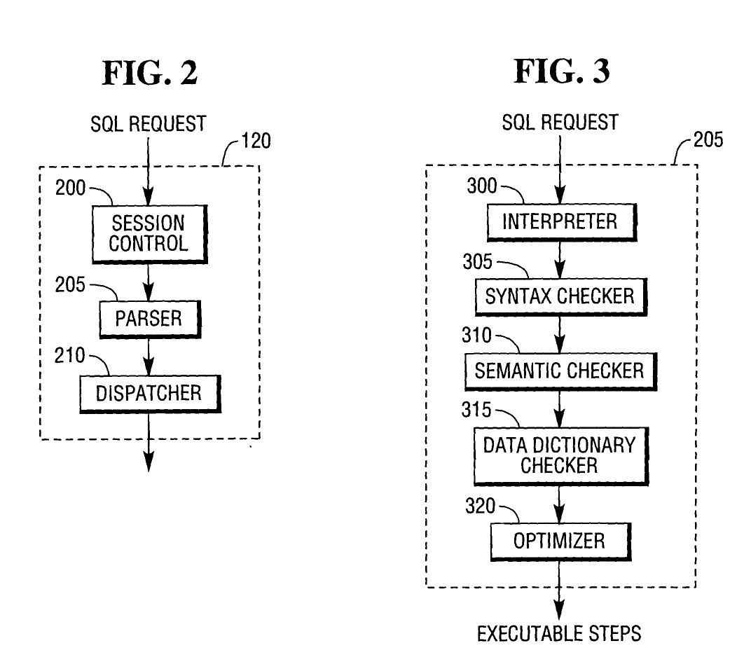

In one example system, the parsing engine 120 is made up of three components: a session control 200, a parser 205, and a dispatcher 210, as shown in FIG. 2. The session control 200 provides the log on and log off function. It accepts a request for authorization to access the database, verifies it, and then either allows or disallows the access.

Once the session control 200 allows a session to begin, a user may submit a SQL request, which is routed to the parser 205. As illustrated in FIG. 3, the parser 205 interprets the SQL request (block 300), checks it for proper SQL syntax (block 305), evaluates it semantically (block 310), and consults a data dictionary to ensure that all of the objects specified in the SQL request actually exist and the user has the authority to perform the request (block 315). Finally, the parser 205 runs an optimizer (block 320) which develops the least expensive plan to perform the request. As described below, the optimizer performs join elimination on a user query in circumstances where such join elimination would enable an improvement and performance of execution of the query.

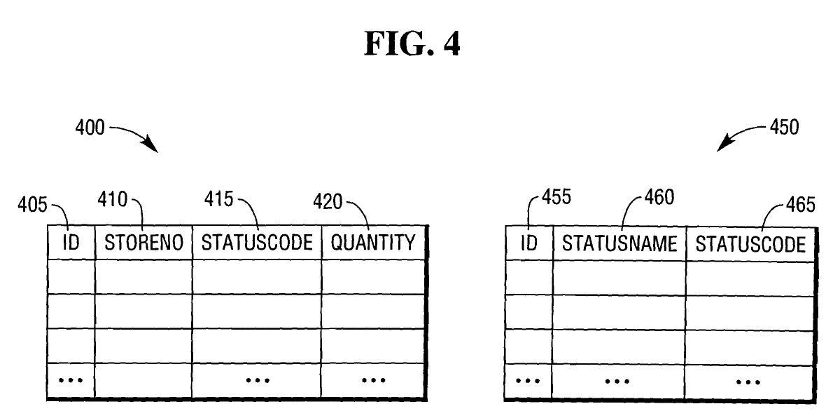

FIG. 4 shows two database tables that may appear in a traditional data warehousing system. The fact table 400 includes several columns. Example columns include row identifier (ID column 405), the number of the store (storeno column 410), a status code (statuscode column 415) and the quantity of products stored (quantity column 420).

Further details of status codes are stored in itemstatus table 450. Itemstatus table 450 includes row identifier (ID column 455), a status name (statusname column 460) and a status code (statuscode column 465).

A typical user query for the database shown in FIG. 4 is as follows:

```
SELECT COUNT (*)
FROM fact f, itemstatus i
WHERE f.storeno IN (1, 4, 5, 7, 8, 13, 14, 27, 28,
    50, 51)
    AND f.statuscode = i.statuscode
    AND i.statusname = ’ACTIVE’
```

The above query has two input relations, the first is the fact table 400 and the second is the itemstatus table 450.

In order to evaluate the query the system must retrieve data from fact table 400 and itemstatus table 450 and perform a join in order to construct an intermediate result set. This intermediate result set is then tested against the remaining predicates in the query in order to generate the results of the query.

Most database operations have an associated cost. This cost depends on factors such as whether the database supports pipelining and/or compiled evaluation instructions. Other factors include the size limits of a particular processing step or the geography of the input tables.

The cost of joining two such tables in some cases will be relatively high, particularly where many of the rows of the joined intermediate result set are discarded as they do not satisfy the remaining conditions of the query.

In one example the cardinality of the selected itemstatus domain values from the itemstatus table 450 is relatively small, namely, the domain size of the join column(s) is small. Itemstatus table 450 may include many rows of data but the number of selected unique data values could be relatively low. In one example the selected unique itemstatuscode values that have ACTIVE itemstatus could be 1, 2 or 3. But while there could be many rows in the itemstatus table 450, in each row where a status name is ACTIVE the statuscode is either 1, 2 or 3. This means that the cost of executing the original query including the join will be higher than an equivalent query rewritten to avoid the join.

If the cost of executing the query is higher than an equivalent query that includes a constant expression but no join, then the optimizer rewrites the query by replacing the input relation in the query with the constant expression. In the above example there are only three distinct statuscode values in itemstatus table that have ACTIVE itemstatus.

The optimizer rewrites the user query to create a new query as follows:

```
SELECT COUNT (*)
FROM fact f
WHERE f.storeno IN (1, 4, 5, 7, 8, 13, 14, 27, 28,
    50, 51)
    AND f.statuscode IN (1, 2, 3)
```

In the above revised query, the input relation based on itemstatus table i has been removed to avoid the cost of the join. The join has effectively been replaced by the condition that f.statuscode has a value of either 1, 2 or 3. The cost of executing the original query was higher than the cost of executing the revised query.

In each case there will be at least two input relations in the user query. One or more of these input relations is/are replaced by one or more constant expressions.

In one form the optimizer evaluates the domain size of the join column(s) of the input relations, for example actual statuscode values in itemstatus table, for each new query. For each query itemstatus table is evaluated and the number of distinct statuscode values is identified.

In one technique the constant expression(s) is/are computed based on data retrieved from the table being replaced during query optimization. This data includes the distinct values of the input relation. The data in one technique is stored in computer memory for subsequent retrieval, and in another technique is obtained during query optimization.

An alternative technique is where the optimizer stores the distinct values of, for example, statuscode values in memory and retrieves these values and/or the constant expression(s) from computer memory in order to insert the constant expression(s) into the optimized query. Where the distinct values or the constant expression are maintained in memory it is necessary to identify any triggering event having the potential to alter the distinct values of any of the input relations. One example of a triggering event is a “write” instruction involving the table that is the subject of the input relation.

The above technique has the potential to optimize user database queries by eliminating the necessity of generating intermediate result sets in non pipelined environments.

The text above describes one or more specific embodiments of a broader invention. The invention also is carried out in a variety of alternative embodiments and thus is not limited to those described here. Those other embodiments are also within the scope of the following claims.

We claim:

1. A method for use in retrieving from a database system data stored in one or more tables, the method comprising:
evaluating a domain size of one or more join columns of at least one input relation in a database query having at least two input relations;
concluding that the domain size of the one or more join columns of at least one evaluated input relation is relatively small; and
in response, replacing the evaluated input relation in the query with one or more constant expressions before executing the query.

2. The method of claim 1, where replacing the evaluated input relation in the query with one or more constant expressions includes creating one or more constant expressions to insert into the query.

3. The method of claim 1, where replacing the evaluated input relation in the query with one or more constant expressions includes retrieving one or more constant expressions from computer memory to insert into the query.

4. The method of claim 1, where evaluating the domain size of the one or more join columns comprises checking results maintained in computer memory, the results previously obtained by counting the number of distinct values in the input relations.

5. A method for use in retrieving from a database system data stored in one or more tables, the method comprising:
evaluating a cost of executing a database query having at least two input relations;
concluding that the cost of executing the query is higher than the cost of executing an equivalent query that includes one or more constant expressions; and
in response, replacing at least one input relation in the query with one or more of the constant expressions before executing the query.

6. The method of claim 5, where replacing the input relation in the query with one or more constant expressions includes creating one or more constant expressions to insert into the query.

7. The method of claim 5, where replacing the input relation in the query with one or more constant expressions includes retrieving one or more constant expressions from computer memory to insert into the query.

8. The method of claim 5, where evaluating the cost of executing the query comprises checking results maintained in computer memory, the results previously obtained by counting the number of distinct values in the input relations.

9. A method for use in optimizing a database query for retrieving from a database system data stored in one or more tables, the database query having at least two input relations, the method comprising:
evaluating a domain size of one or more join columns of at least one of the input relations in the database query;
concluding that the domain size of the one or more join columns of at least one evaluated input relation is relatively small; and
in response, replacing the evaluated input relation in the query with one or more constant expressions.

10. The method of claim 9, where replacing the evaluated input relation in the query with one or more constant expressions includes creating one or more constant expressions to insert into the query.

11. The method of claim 9, where replacing the evaluated input relation in the query with one or more constant expressions includes retrieving one or more constant expressions from computer memory to insert into the query.

12. The method of claim 9, where evaluating the domain size of the one or more join columns of the input relations comprises checking results maintained in computer memory, the results previously obtained by counting the number of distinct values in the input relations.

13. A method for use in optimizing a database query for retrieving from a database system data stored in one or more tables, the database query having at least two input relations, the method comprising:
evaluating a cost of executing the query;
concluding that the cost of executing the query is higher than the cost of executing an equivalent query that includes one or more constant expressions; and
in response, replacing at least one input relation in the query with one or more constant expressions.

14. The method of claim 13, where replacing the input relation in the query with one or more constant expressions includes creating one or more constant expressions to insert into the query.

15. The method of claim 13, where replacing the input relation in the query with one or more constant expressions includes retrieving one or more constant expressions from computer memory to insert into the query.

16. The method of claim 13, where evaluating the cost of executing the query comprises checking results maintained in computer memory, the results previously obtained by counting the number of distinct values in the input relations.

17. A database system including one or more tables of data stored on one or more storage facilities and managed by one or more processing units, the system comprising:
a parsing engine configured to receive a database query having at least two input relations and to coordinate retrieval of data from one or more of the tables in response to the database query; and
a query optimizer configured to:
evaluate a domain size of at least one input relation and conclude that the domain size of the input relation is relatively small; and
in response, replace the input relation in the database query with a constant expression.

18. The database system of claim 17, where the query optimizer is further configured to create one or more constant expressions to replace the input relation in the database query with the constant expression.

19. The database system of claim 17, where the query optimizer is further configured to retrieve one or more constant expressions from computer memory in order to replace the input relation in the database query with the constant expression.

20. The database system of claim 17, where the query optimizer is configured to evaluate the domain size of a join column of the input relation by checking results maintained in computer memory, the results previously obtained by counting the number of distinct values in the input relations.

21. A database system including one or more tables of data stored on one or more storage facilities and managed by one or more processing units, the system comprising:
a parsing engine configured to receive a database query having at least two input relations and to coordinate retrieval of data from one or more of the tables in response to the database query; and
a query optimizer configured to:
evaluate a cost of executing the query and conclude that the cost of executing the query is higher than the cost of executing an equivalent query that includes one or more constant expressions; and
in response, replace at least one of the input relations in the database query with one or more of the constant expressions.

22. The database system of claim 21, where the query optimizer is further configured to create one or more constant expressions to replace the input relation in the database query with the constant expression.

23. The database system of claim 21, where the query optimizer is further configured to retrieve one or more constant expressions from computer memory in order to replace the input relation in the database query with the constant expression.

24. The database system of claim 21, where the query optimizer is configured to evaluate a domain size of one or more join columns of the input relations by checking results maintained in computer memory, the results previously obtained by counting the number of distinct values in the input relations.
